(19) United States
(12) Patent Application Publication
(10) Pub. No.: US 2013/0282654 A1
(43) Pub. Date: Oct. 24, 2013

(54) QUERY ENGINE COMMUNICATION

(71) Applicants: Qiming Chen, Cupertino, CA (US); Meichun Hsu, Los Altos Hills, CA (US)

(72) Inventors: Qiming Chen, Cupertino, CA (US); Meichun Hsu, Los Altos Hills, CA (US)

(21) Appl. No.: 13/454,693

(22) Filed: Apr. 24, 2012

(51) Int. Cl. G06F 17/30; G06F 15/16

(52) U.S. Cl. 707/610; 707/770; 707/E17.014; 707/E17.005

(57) ABSTRACT

There is provided a computer-implemented method of performing inter-query engine communication. The method includes receiving a message from a first query engine agent over a signal communication network. The first query engine agent is associated with a first query engine. The method also includes determining, by a second query engine agent associated with a second query engine, a data exchange to perform based on the message. Additionally, the method includes performing the data exchange over a data communication network.

### BACKGROUND

A query engine is a component of a database management system (DBMS) that executes a query and provides a result. In some implementations, servers within a cluster may each have a query engine and their own local databases. Depending on the particular database applications, a query engine may provide its results to one or more other query engines within the cluster of servers. Query engines may also import and export data between their local databases. In such implementations, the query engines communicate amongst themselves to coordinate the exchange of data. Such a configuration can be used for data warehousing, parallel processing, and various other applications.

For example, query engine grids are used to scale-out data-intensive applications, and include multiple, distributed query engines that intercommunicate. An application running on one query engine may request data from a database managed by another query engine. The query engines communicate to enable the appropriate data transfers.

### BRIEF DESCRIPTION OF THE DRAWINGS

Certain exemplary embodiments are described in the following detailed description and in reference to the drawings, in which:

FIG. 1 is a block diagram of an example system for inter-query engine communication;

FIG. 2 is a diagram of a computer node in an example system for inter-query engine communication;

FIG. 3 is a flow chart of a method for inter-query engine communication;

FIG. 4 is a block diagram of a system for inter-query engine communication; and

FIG. 5 is a block diagram showing a tangible, non-transitory, machine-readable medium that stores code adapted for inter-query engine communication.

### DETAILED DESCRIPTION OF SPECIFIC EXAMPLES

For export-imports, the participating query engines may share metadata, such as table names, schemas, and the like. For example, given two query engines: QE1 and QE2, the process for QE1 to export data for QE2 to import, can involve the following steps: (1) QE1 sends a message, telling QE2 the data import intention; (2) QE2 provides a named pipe on a network file system mounted drive, and notifies QE1 in the reply message; (3) QE1 sets up the export query to export the selected data to the pipe, and notifies QE2; (4) QE2 imports the data from the pipe; (5) When the export finishes, QE1 send a message with the end-of-data signal; (6) QE2 empties the pipe and destroys the pipe.

Typically, the data communication channel is export-import. If not statically configured, inter-query engine conversation describes when, what, and where to import and export. In data-intensive applications, communicating this information over the same channel as the data being transferred can impact the efficiency of inter-query engine communication. Accordingly, in an example embodiment, networks of query engines, e.g., query engine grids, include both a data channel and a separate signal channel for multiple query engine collaboration. While the basic function of inter-query engine messaging is to set-up and tear-down data communication, the messages captured in the signal channel may also be used in a wide variety of applications, including, but not limited to, query engine network monitoring, resource planning, and fraud detection, among others. Additionally, the inter-query engine messages may be analyzed on-line or off-line.

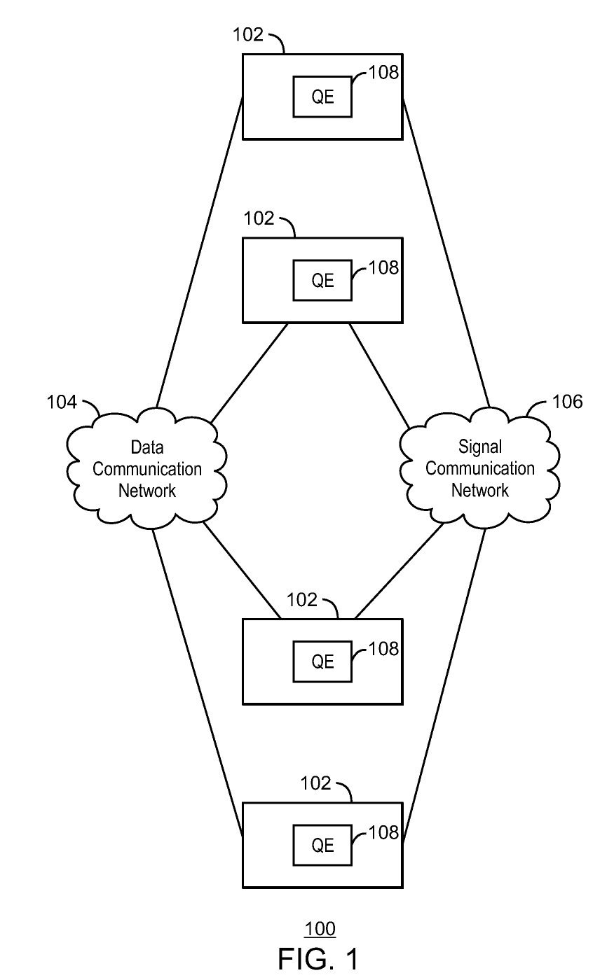

FIG. 1 is a block diagram of an example system 100 for inter-query engine communication. The system 100 includes a number of servers 102 in communication over a data communication network 104 and a signal communication network 106. The servers 102 may be computing nodes. The data communication network 104 and signal communication networks 106 may be virtual networks used for passing data from one server 102 to another. The signal communication network 106 is used to pass messages between the servers 102. The messages passed over signal communication network 106 may be used to conduct a conversation between two servers 102 between which data is being passed. The data communication network 104 is used to transfer data between the servers 102. The data communication network 104 is separate from the signal communication network 106

For example, the data communication network 104 and the signal communication network 106 can be separate virtual networks. That is, for example, data communication network 104 can be logically separate from signal communication network 106. As an example of logical separation between networks, the Signalling System No. 7 (SS7) implements a signal network and a voice network over a common medium. The signal network and the voice network are logically separated based on the types of payloads, control values or symbols, or a combination thereof. In another example, the data communication network 104 and the signal communication network 106 are physically separate. For example, communication via the data communication network 104 can be supported or realized at one medium (e.g., a fiber optic cable) and communication via the signal communication network 106 can be supported or realized at another medium (e.g., a copper cable). In some implementations, the communication can be a wireless communication and a medium can be free space.

In examples, the servers 102 may be configured as a server cluster. The servers 102 each include a query engine 108 and local databases (not shown). The query engines 108 exchange messages over the signal communication network 106 to facilitate the exchange of data over the data communication network 104. The exchanged data is used by applications running on the servers 102.

In examples, the servers 102 may form a query engine grid (QE-Grid). A QE-Grid is an elastic stream analytics infrastructure. The QE-Grid is made up of multiple query engines on a server cluster with high-speed interconnection. The QE-Grid may be a grid of analysis engines serving as executors of Structured Query Language (SQL)-based dataflow operations. The function of the QE-Grid is to execute graph-based data streaming, rather than to offer distributed data stores.

The query engines in a QE-Grid are dynamically configured for executing a SQL Streaming Process, which, compared with a statically configured Map-Reduce platform, offers enhanced flexibility and availability. In such an embodiment, the query engine 202 is able to execute multiple continuous queries (CQs) belonging to multiple processes, and therefore can be used in the execution of multiple processes. The QE-Grid may use a common language, such as SQL, across the server cluster, making it homogeneous at the streaming process level. In an example embodiment of heterogeneous servers, the servers 102 all run query engines 202 with the capability of query-based data analysis.

For streaming analytics, the queries on the QE_Grid are stationed CQs with data-driven executions, and synchronized by the common data chunking criterion. The query results are exchanged through writing to, or reading from, a unified share-memory across multiple servers 102. In an example, the query results are exchanged using a Distributed Caching Platform (DCP).

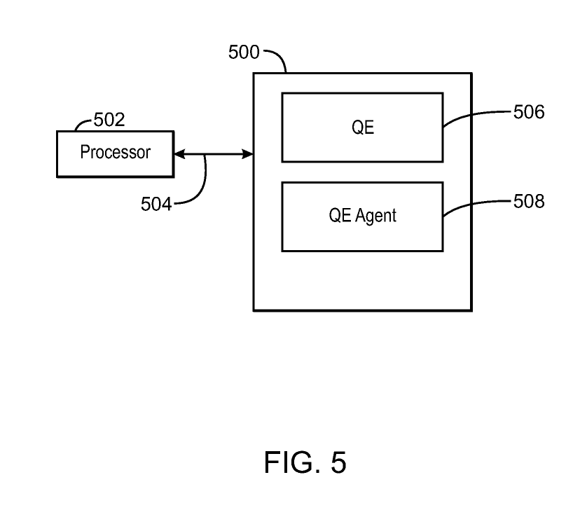

As illustrated in FIG. 5, a DCP virtualizes the memories on multiple servers as an integrated memory. Further, the DCP provides simple application program interfaces (APIs) for key-value based data caching and accessing, such as get( ) put( ) delete( ) etc, where keys and values are objects. The cached content may be read-through or written-through a database. DCP offers the benefits of high performance and low latency by avoiding disk access. DCP also supports scalability and availability, particularly when data is too big to fit in the memory space of a single server 102.

Inter-query engine communication may also involve elastic cloud services. For example, given an application 206, an elastic cloud service is able to generate and optimize an execution plan, allocate system resources, provide utilities, and the like, in a way that is transparent to the user of the services. Such elastic service provisioning is dynamic in the sense that the service provisioning is tailored on a per-application basis. However, such service provisioning is also static in the sense that the service is typically configured before the application 206 starts.

In contrast, an example embodiment enables the use of more flexible applications 206 that use on demand, run-time data communications. Additionally, signal channel messaging may be used to prepare, enable and monitor inter-query engine communication. In this way, cloud service provisioning elasticity may be improved.

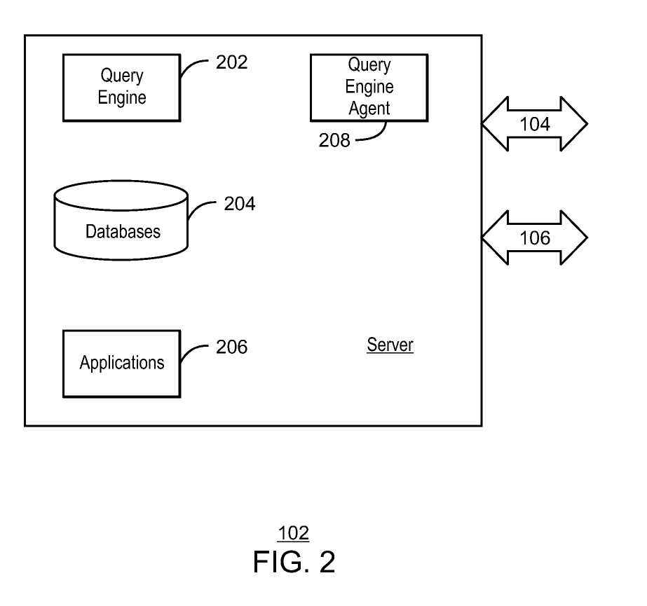

FIG. 2 is a diagram of a server 102 in an example system for inter-query engine communication. The server 102 includes a query engine 202, local databases 204, applications 206, and a query engine agent 208. Each query engine 202 is associated with a query engine agent 208. The query engine agents 208 exchange messages across the signal communication network 106. In response to a received message, and according to message type, the query engine agents 208 make data available to query engines 202 using the data communication network 104.

Specific messaging functionalities may be individually tailored for specific applications 206. However, to provide general messaging functionalities to be used by all applications 206, an example embodiment includes the query engine agent 208 hosted by each query engine 202. The query engine agent 208 handles messaging, and supports data communication on behalf of the host query engine 202. The query engine agent 208 also interfaces with the database applications 206 on the host query engine 202 through one or more APIs, for example.

In one example, an online transaction processing (OLTP) application running on a PostgreSQL query engine, may be configured to warehouse a dataset when the dataset volume reaches a specified threshold. The PostgreSQL query engine is an open source query engine. In such an embodiment, the dataset may be warehoused to an online analytical processing (OLAP) database running on a parallel database system.

In another example, an application 206 may be configured to use the most current version of a dimension table residing in a database 204 on another server 102. For example, the application 206 may use query agents 208 to dynamically replicate the dimension table to the local database during execution of the application 206.

Additionally, in a distributed database environment, data partitions may be used to improve the efficiency of distributed database applications 206. However, it may be time consuming to pre-partition data to accommodate each individual application 206 running against the distributed database. In an example, database applications 206 may use on-demand data replication and re-partitioning during execution. Such embodiments support flexible, on-demand, run-time data communication.

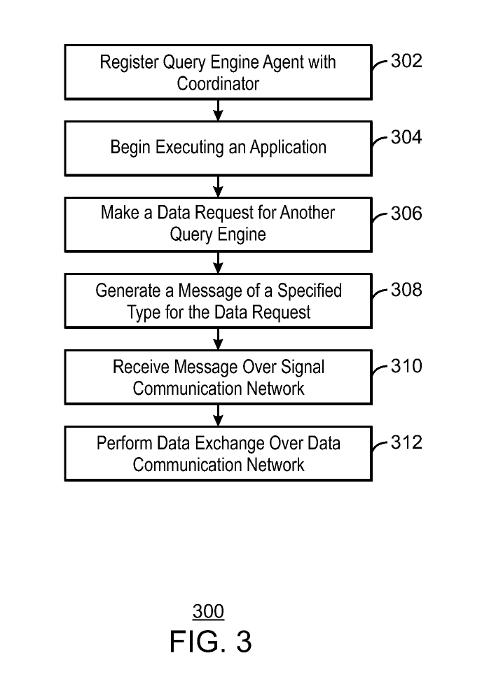

FIG. 3 is a flow chart of a method 300 for inter-query engine communication. The method 300 may be performed by the query engine 202 and the query engine agent 208, and begins at block 302, where the query engine agent 208 registers with a coordinator query agent. Each query engine agent 208 registers their address with the coordinator query agent.

At block 304, the query engine 202 may begin executing an application 206. At block 306, the application 206 may make a data request for another query engine 202. The data request may be related to importing data, exporting data, providing a result, requesting a result, and the like.

At block 306, the application 206 makes a data request to another query engine 202. At block 308, the query engine agent 208 generates a message for the data request. The message can include a message type that represents the payload type based on the context of messages exchanged between the query engine agents 208. For example, message types of import pipe or export pipe may specify a location of the import pipe or export pipe. In some cases, the query engine agent 208 may not have the address for the recipient query engine agent 208. In such cases, the query engine agent 208 may query a coordinator agent to provide the address.

At block 310, the generated message is received by a recipient query engine agent via the signal communication network 106. At block 312, the recipient query engine agent 208 may perform a data exchange over the data communication network 104 based on the message type. For example, for the import pipe message type, the recipient query engine agent 208 may export its local data to the location of the import pipe specified in the message.

FIG. 3 is not intended to indicate that blocks 302-312 are to be executed in any particular order. In addition, any of the blocks 302-312 may be deleted, or any number of additional processes may be added to the method 300, depending on the details of a specific implementation.

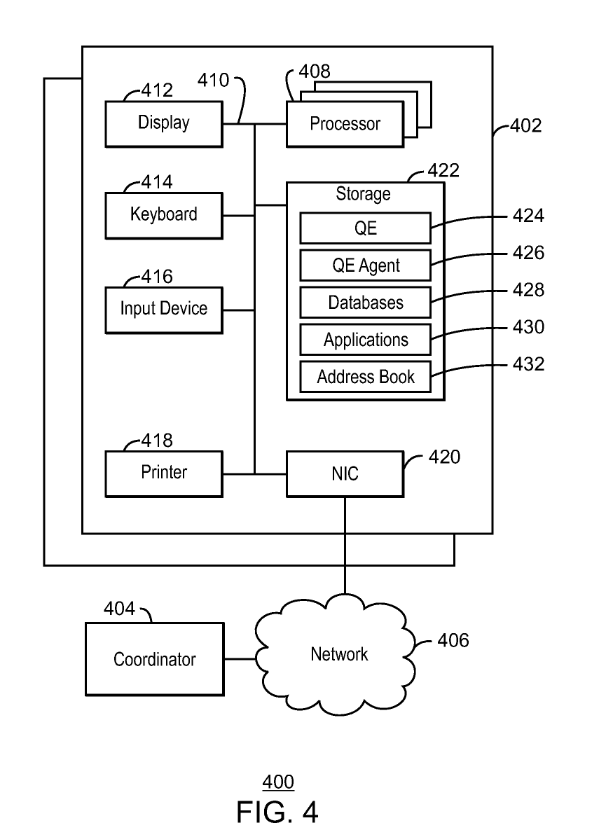

FIG. 4 is a block diagram of a system 400 for inter-query engine communication, in accordance with embodiments. The functional blocks and devices shown in FIG. 4 may comprise hardware elements, software elements, or some combination of software and hardware. The hardware elements may include circuitry. The software elements may include computer code stored as machine-readable instructions on a non-transitory, computer-readable medium. Additionally, the functional blocks and devices of the system 400 are but one example of functional blocks and devices that may be implemented in an example. Specific functional blocks may be defined based on design considerations for a particular electronic device.

The system 400 may represent the system 100, and includes nodes 402, in communication with coordinator node 404, over a network 406. The node 402 may include a processor 408, which may be connected through a bus 410 to a display 412, a keyboard 414, an input device 416, and an output device, such as a printer 418. The input devices 416 may include devices such as a mouse or touch screen. The server node 402 may also be connected through the bus 410 to a network interface card 420. The network interface card 420 may connect the server 402 to the network 406. The network 406 may be a local area network, a wide area network, such as the Internet, or another network configuration. The network 406 may include routers, switches, modems, or any other kind of interface device used for interconnection. In one example, the network 406 may be the Internet. The network 406 may include the data communication network 104 and the signal channel network 106.

The node 402 may have other units operatively coupled to the processor 412 through the bus 410. These units may include non-transitory, computer-readable storage media, such as storage 422. The storage 422 may include media for the long-term storage of operating software and data, such as hard drives. The storage 422 may also include other types of non-transitory, computer-readable media, such as read-only memory and random access memory.

The storage 422 may include the machine readable instructions used in examples of the present techniques. In an example, the storage 422 may include a query engine 424, query engine agent 426, local databases 428, applications 430, and an address book 432. The query engine agent 426 may exchange messages over the signal communication network 106 with other query engine agents 426 in order to exchange data from the local databases 428 over the data communication network 104. Each node 402 may include an address book 432 of query engine agents 426 across the system 400. The coordinator node 404 may provide addresses of query engines across a cluster of nodes 402.

FIG. 5 is a block diagram showing a tangible, non-transitory, machine-readable medium that stores code adapted for inter-query engine communication. The machine-readable medium is generally referred to by the reference number 500. The machine-readable medium 500 may correspond to any typical storage device that stores computer-implemented instructions, such as programming code or the like. Moreover, the machine-readable medium 500 may be included in the storage 422 shown in FIG. 4.

When read and executed by a processor 502, the instructions stored on the machine-readable medium 500 are adapted to cause the processor 502 to perform inter-query engine communication. The medium 500 includes a query engine 506, an associated query engine agent 508, a data communication network 510, and a signal communication network 512. The query engine agent 508 may exchange data across the data communication network 510 from one query engine 508 to another by sending messages with typed payloads over the signal communication network 512.

The block diagram of FIG. 5 is not intended to indicate that the tangible, non-transitory computer-readable medium 500 is to include all of the components shown in FIG. 4. Further, any number of additional components may be included within the tangible, non-transitory computer-readable medium 400, depending on the details of a specific implementation.

While the present techniques may be susceptible to various modifications and alternative forms, the examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

1. A method comprising:
receiving a message from a first query engine agent over a signal communication network, wherein the first query engine agent is associated with a first query engine, and wherein the signal communication network comprises a first virtual network;
determining, by a second query engine agent associated with a second query engine, a data exchange to perform based on the message, and wherein the data communication network comprises a second virtual network; and
performing the data exchange over a data communication network.

2. The method recited by claim 1, wherein the message comprises a payload of a specified type, and wherein determining the data exchange to perform is based on the specified type.

3. The method recited by claim 2, wherein the specified type comprises one of:
an import pipe; and
an export pipe.

4. The method recited by claim 1, wherein the data exchange comprises replicating a database view from a local database of the first query engine to a local database of the second query engine, and wherein the data exchange is requested by an application of the second query engine during execution of the application.

5. The method recited by claim 1, wherein the data exchange comprises an import-export operation from a local database of the first query engine to a local database of the second query engine, and wherein the data exchange is requested by an application of the second query engine during execution of the application.

6. The method recited by claim 1, comprising requesting an address of the first query engine agent from a coordinator query engine agent, wherein the first query engine agent is registered with the coordinator query engine agent, and the second query engine agent is registered with the coordinator query engine agent.

7. The method recited by claim 6, comprising looking up an address of the first query engine agent in an address book of the second query engine agent.

8. The method recited by claim 1, wherein the data exchange comprises warehousing a data set associated with the second query engine when a size of the data set exceeds a specified threshold.

9. A system for inter-query engine communication, comprising:
a signal communication network, wherein the signal communication network comprises a first virtual network;
a data communication network, wherein the data communication network comprises a second virtual network; and
a plurality of computing nodes in communication with each other over the signal communication network and the data communication network, wherein each computing node comprises:
a processor configured to execute stored instructions; and
a memory device comprising:
a first query engine; and
a first query engine agent associated with the first query engine, wherein the first query engine agent is configured to:
send a message to a second query engine agent associated with a second query engine over the signal communication network;
retrieve the data from the second query engine over the data communication network based on a response from the second query engine agent received over the signal communication network; and
make the data from the second query engine available to the first query engine.

10. The system of claim 9, wherein the plurality of computing nodes comprises a server cluster.

11. The system of claim 9, wherein the plurality of computing nodes comprises a query engine grid.

12. The system of claim 9, wherein the plurality of computing nodes comprises a parallel database management system.

13. The system of claim 9, wherein the plurality of computing nodes comprises a data warehouse.

14. A tangible, non-transitory, machine-readable medium that stores machine-readable instructions executable by a processor to perform inter-query communication, the tangible, non-transitory, machine-readable medium comprising:
machine-readable instructions that, when executed by the processor, receive a message from a first query engine agent over a signal communication network, wherein the message comprises a specified type, and wherein the first query engine agent is associated with a first query engine, and wherein the signal communication network comprises a first virtual network;
machine-readable instructions that, when executed by the processor, determine, by a second query engine agent associated with a second query engine, a data exchange to perform based on the specified type; and
machine-readable instructions that, when executed by the processor, perform the data exchange over a data communication network, wherein the data communication network comprises a second virtual network.

15. The tangible, machine-readable medium recited by claim 14, comprising machine-readable instructions that, when executed by the processor, replicate a database view from a local database of the first query engine to a local database of the second query engine, and wherein the data exchange is requested by an application of the second query engine during execution of the application.

16. The tangible, machine-readable medium recited by claim 14, wherein the data exchange comprises an import-export operation from a local database of the first query engine to a local database of the second query engine, and wherein the data exchange is requested by an application of the second query engine during execution of the application.

17. The tangible, machine-readable medium recited by claim 14, wherein the specified type comprises one of:
an import pipe; and
an export pipe.

18. The tangible, machine-readable medium recited by claim 14, comprising machine-readable instructions that, when executed by the processor, request an address of the first query engine agent from a coordinator query engine agent.

19. The tangible, machine-readable medium recited by claim 18, comprising machine-readable instructions that, when executed by the processor, look up an address of the first query engine agent in an address book of the second query engine agent.

20. The tangible, machine-readable medium recited by claim 14, wherein the data exchange comprises warehousing a data set associated with the second query engine when a size of the data set exceeds a specified threshold.
